(19) United States
(12) Patent Application Publication
(10) Pub. No.: US 2014/0113536 A1
(43) Pub. Date: Apr. 24, 2014

(54) ZONAL AIRFLOW SYSTEM FOR A VEHICLE

(71) Applicant: VISTEON GLOBAL TECHNOLOGIES, INC., Van Buren Twp., MI (US)

(72) Inventors: Lakhi Nandlal Goenka, Ann Arbor, MI (US); Gabriel Munro, Northville, MI (US)

(73) Assignee: VISTEON GLOBAL TECHNOLOGIES, INC., Van Buren Twp., MI (US)

(21) Appl. No.: 13/657,936

(22) Filed: Oct. 23, 2012

(51) Int. Cl. B60H 1/34

(52) U.S. Cl. 454/152

(57) ABSTRACT

A fluid flow system of the present invention includes a supply source for conditioning a flow of fluid and a plurality of ducts for delivering the conditioned fluid to a passenger compartment of a vehicle. One of the ducts is a discharge device having an outer peripheral wall and a flow distribution assembly. The outer peripheral wall and the flow distribution assembly are configured to improve a distribution of the fluid to the passenger compartment. The flow distribution assembly includes a plurality of plates having various thicknesses and flow paths of different sizes and spacing formed therein to direct and substantially uniform distribute the fluid, maximizing a performance and an efficiency of the fluid flow system.

### FIELD OF THE INVENTION

The present invention relates to a fluid flow system, and more particularly to a zonal airflow system for a heating, ventilating, and fluid-conditioning a passenger compartment of a vehicle.

### BACKGROUND OF THE INVENTION

Presently there are numerous airflow systems for heating, ventilating, and fluid-conditioning a passenger compartment of a vehicle which are designed to provide airflows of diverse temperatures to various zones of the passenger compartment. Most airflow systems are disposed between a dashboard and an engine compartment of the vehicle. The systems are typically provided with a fan which draws ambient air from the outside or air from inside the vehicle to be heated within a radiator by a cooling fluid from the engine or cooled within a thermal energy exchanger. The conditioned air is then directed by a network of ducts having a plurality of passages for delivering the conditioned air to various locations within the passenger compartment in accordance with the needs of the passengers. Typically, the ducts discharge directly into vents of the dashboard to ensure a comfort of the passengers seated at a front of the vehicle and a defrosting of a windshield thereof. The ducts also extend to a rear of the vehicle, generally hidden among interior structure such as a center console or door sill moldings, for example.

Other conventionally-known airflow systems include a network of ducts employed in a headliner of the vehicle. Typically, the ducts discharge directly into vents of the headliner to ensure a comfort of the passengers seated at a center and/or rear of the vehicle. The vents include positionable grilles to adjust a direction of flow of the conditioned air. A drawback of such airflow systems is that a flow speed, volume, and a distribution of the conditioned air are inconsistent.

Thus, it would be desirable to produce a fluid flow system including a plurality of ducts each having a passage formed therein for delivering conditioned fluid to various locations within the passenger compartment which results in uniform flow distribution of the conditioned fluid discharged from the fluid flow system into the passenger compartment. However, because of limited space in the headliner of the vehicle, the ducts must meet certain size and packaging constraints, making the uniform flow distribution of the conditioned fluid discharged from the fluid flow system into the passenger compartment difficult and costly to attain. Accordingly, it is further desirable to design the fluid flow system to include a discharge device which substantially uniformly distributes the conditioned fluid discharged from the fluid flow system into the passenger compartment, wherein a performance and an efficiency of the fluid flow system are maximized, while a package size and a cost thereof are minimized.

### SUMMARY OF THE INVENTION

In concordance and agreement with the present invention, a fluid flow system including a discharge device which substantially uniformly distributes a fluid flow discharged from the fluid flow system into the passenger compartment, wherein a performance and an efficiency of the fluid flow system are maximized, while a package size and a cost thereof are minimized, has surprisingly been discovered.

In one embodiment, a discharge device for a fluid flow system, comprises: a flow distribution assembly including a plurality of plates in stacked relation, each of the plates having a plurality of flow paths formed therein.

In another embodiment, a discharge device for a fluid flow system, comprises: an outer wall; and a flow distribution assembly coupled to the outer wall to form a chamber for receiving a fluid flow therein, wherein the flow distribution assembly includes a plurality of plates, each of the plates having a plurality of flow paths formed therein, wherein at least one of the plates is configured to at least one of substantially uniformly distribute the fluid flow among the flow paths of the at least one of the plates, direct the fluid flow in a direction substantially perpendicular to a general direction of the fluid flow into the discharge device, and increase a velocity of the fluid flow from the discharge device.

In yet another embodiment, a fluid flow system, comprises: a supply source for providing a fluid flow; at least one duct fluidly connected to the supply source; and a discharge device fluidly connected to the at least one duct, the discharge device including a flow distribution assembly including a substantially planar first plate, a substantially planar second plate, and a substantially planar third plate, each of the first plate, the second plate, and the third plate having a plurality of flow paths formed therein, wherein the first plate is configured to substantially uniformly distribute a fluid flow among the flow paths of the first plate, the second plate is configured to direct the fluid flow in a direction substantially perpendicular to a general direction of the fluid flow into the discharge device, and the third plate is configured to increase a velocity of the fluid flow from the discharge device.

### DESCRIPTION OF THE DRAWINGS

The above, as well as other advantages of the present invention, will become readily apparent to those skilled in the art from the following detailed description, when considered in the light of the accompanying drawings:

FIG. 1 is a schematic rear perspective view of a fluid flow system according to an embodiment of the invention, wherein the fluid flow system is configured to provide conditioned fluid to a passenger compartment of a vehicle;

FIG. 2 is an exploded perspective view a discharge device of the fluid flow system illustrated in FIG. 1; and

FIG. 3 is a fragmentary schematic cross-sectional perspective view of the discharge device illustrated in FIGS. 1-2.

### DESCRIPTION OF THE PREFERRED EMBODIMENT

The following detailed description and appended drawings describe and illustrate various exemplary embodiments of the invention. The description and drawings serve to enable one skilled in the art to make and use the invention, and are not intended to limit the scope of the invention in any manner.

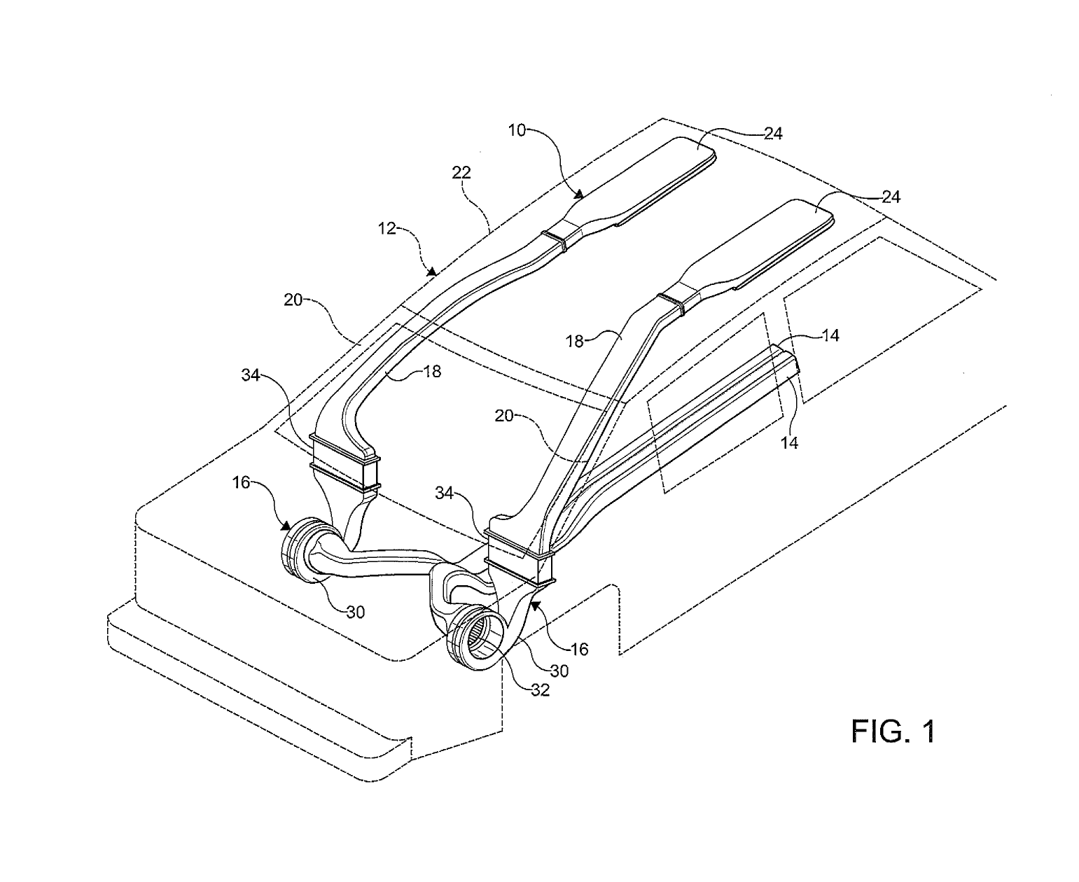

FIG. 1 shows a fluid flow system 10 according to the present invention. The fluid flow system 10 shown is a zonal airflow system for providing conditioned fluid to various locations of a passenger compartment of a vehicle 12. The fluid flow system 10 shown includes a plurality of inlet ducts 14 extending along a floor towards a front of the vehicle 12, a plurality of supply sources 16 fluidly connected to the respective inlet ducts 14, a plurality of spaced apart pillar ducts 18 fluidly connected to the respective supply sources 16 and extending along a rear pillar 20 to a headliner 22 of the vehicle 12, and a plurality of discharge devices 24 fluidly connected to the respective pillar ducts 18 and extending along the headliner 22 towards the front of the vehicle 12. It is understood that the fluid flow system 10 may include additional or fewer inlet ducts 14, supply sources 16, pillar ducts 18, and discharge devices 24 than shown.

Each of the inlet ducts 14 has an inlet opening (not shown) to receive a flow of a fluid (i.e. ambient fluid from outside of the vehicle 12 or recirculated fluid from within the passenger compartment of the vehicle 12) therein. The inlet ducts 14 can be any suitable length extending in any direction as desired and may be provided with an inlet grille (not shown) to militate against undesired particles and debris from entering the fluid flow system 10. It is understood that the pillar ducts 18 and the discharge devices 24 can be any suitable length extending in any direction as desired to cooperate with surrounding structure of the vehicle 12 such as a sunroof, a moon roof, and the like, for example.

As illustrated, each of the supply sources 16 includes a housing 30 having a fluid flow element 32 disposed therein and a conditioning device 34 disposed in or connected to the housing 30. The fluid flow element 32 can be any suitable fluid flow element 32 which causes the fluid to flow through the fluid flow system 10 such as a blower wheel or a fan, for example. The fluid flow element 32 shown is disposed upstream of the conditioning device 34. It is understood, however, that the fluid flow element 32 can be disposed downstream of the conditioning device 34 if desired. The conditioning device 34 is used to condition (i.e. heat or cool) the fluid to a desired temperature prior to the fluid flowing through the pillar duct 18 and the discharge device 24 into the blower passenger compartment of the vehicle 12. The conditioning device 34 can be a thermoelectric device including a hot side and a cold side in communication with the fluid flowing into the passenger compartment. Various other conditioning devices 34 can be employed for use in the fluid flow system 10 such as an evaporator, a positive thermal coefficient (PTC) heater, and a heater core, for example. It is understood that additional conditioning devices 34 than shown can be used as desired.

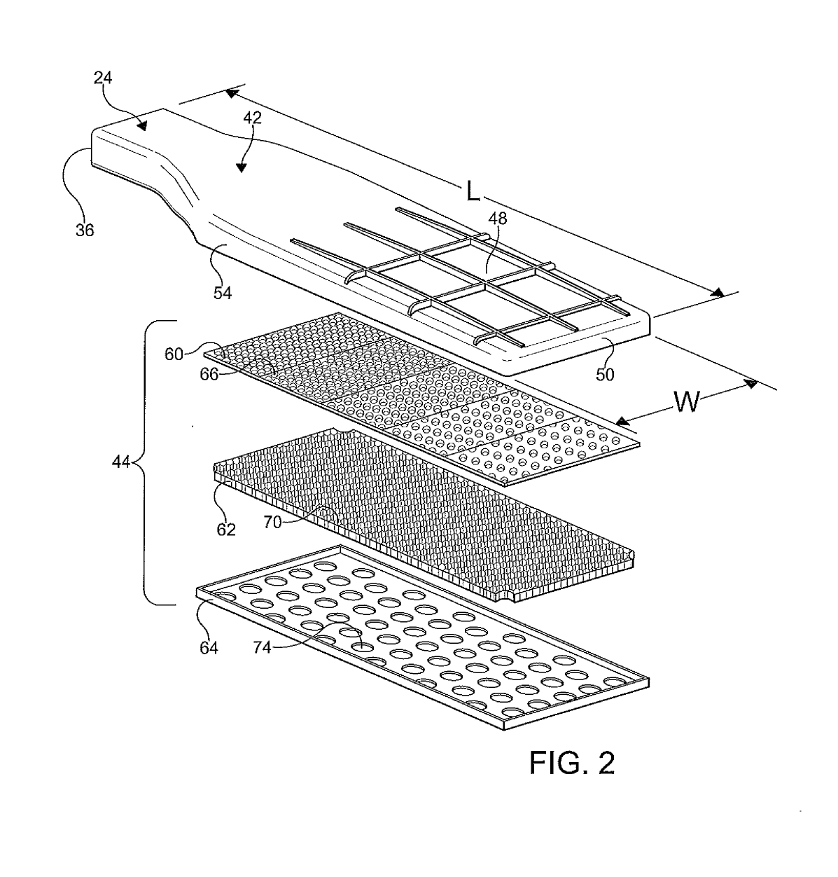

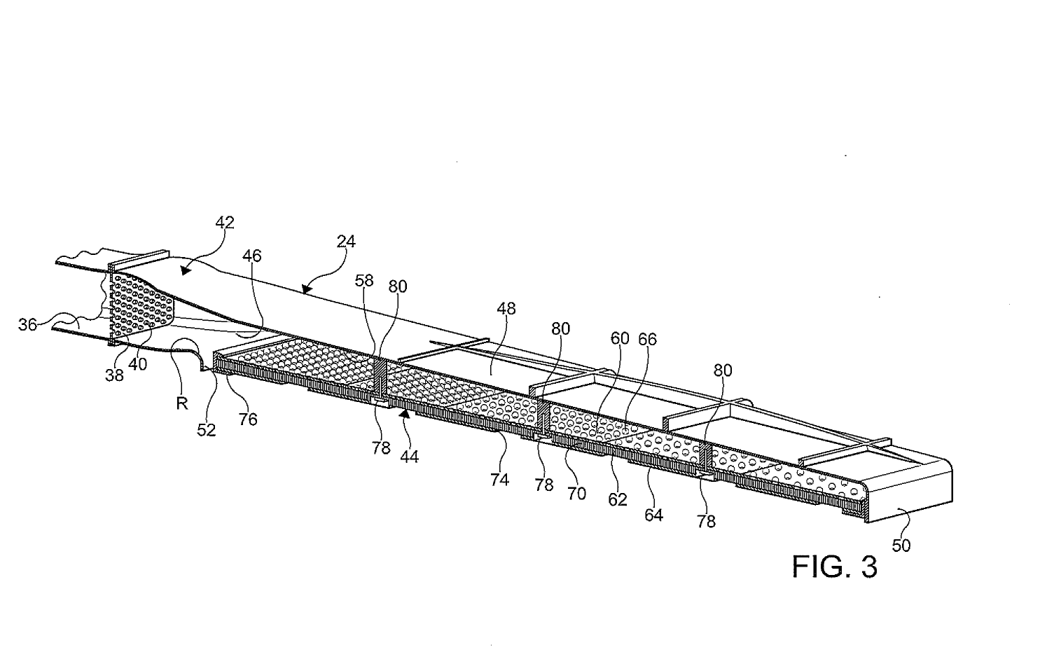

FIGS. 2-3 show one of the discharge devices 24 according to the present invention. In a non-limiting example, the discharge device 24 has a length L in a range of about 400 mm to about 500 mm and a width W in a range of about 200 mm to about 300 mm, and more specifically, the length L is about 487 mm and the width W is about 225 mm. Each of the discharge devices 24 includes an inlet 36. The inlet 36 receives the flow of fluid from the supply source 16 through the pillar duct 18. A diffuser 38 may be disposed in the inlet 36 to distribute the flow of fluid and increase a flow resistance within the inlet 36. In a non-limiting example, the diffuser 38 includes a plurality of flow paths 40 formed therein. It is understood that the diffuser 38 can have any shape and size as desired. As shown in FIG. 3, the flow paths 40 are evenly spaced apart and have substantially the same hydraulic diameter to substantially uniformly distribute the flow of fluid across the width of the discharge device 24. Although the flow paths 40 shown have a circular cross-sectional shape, it is understood that the flow paths 40 can have any cross-sectional shape as desired such as rectangular, square, hexagonal, pentagonal, and the like, for example. It is also understood that the flow paths 40 can be formed in the diffuser 38 in any suitable pattern and have any suitable size, as desired.

The discharge device 24 also includes an outer peripheral wall 42 cooperating with a flow distribution assembly 44 to form a chamber 46 for receiving the flow of fluid therein. In certain embodiments, the outer peripheral wall 42 of the discharge device 24 is formed by an upper wall section 48, a front wall section 50, a rear wall section 52, a first side wall section 54, and a second side wall section (not shown) opposite the first side wall section 54. The upper wall section 48 of the discharge device 24 has an inner surface 58. An insulating layer (not shown) may be formed on the inner surface 58 to insulate the flow of fluid from external temperatures. A thickness of the insulating layer is in a range of about 6 mm to about 8 mm. In certain embodiments, the upper wall section 48 of the discharge device 24 is angled with respect to the flow distribution assembly 44 from the inlet 36 of the discharge device 24 to the front wall section 50 thereof. A radius R is formed in the rear wall section 52 to cause the flow of fluid to curl when entering the chamber 46 and be directed into a region of the flow distribution assembly 44 adjacent thereto. In a non-limiting example, the radius R of the rear wall section 52 is about 0.5 mm.

As illustrated, the flow distribution assembly 44 includes a substantially planar first plate 60, a substantially planar second plate 62, and a substantially planar third plate 64. Each of the plates 60, 62, 64 can be, separately or integrally, formed with the discharge device 24 as desired. Various materials can be used to form each of the plates 60, 62, 64 such as a non-metal material (i.e. plastic), a metal material (i.e. aluminum) material, or a combination thereof, for example. The first plate 60 includes an array of spaced apart flow paths 66 formed through a thickness of the first plate 60. The thickness of the first plate 60 shown is in a range of about 1 mm to about 3 mm. In a non-limiting example, the thickness of the first plate 60 is about 2 mm. It is understood that the first plate 60 can have any suitable dimensions as desired.

The flow of fluid is distributed among the flow paths 66 for a distribution of fluid to the passenger compartment of the vehicle 12. Although the flow paths 66 shown have a circular cross-sectional shape, it is understood that the flow paths 66 can have any cross-sectional shape as desired such as rectangular, square, hexagonal, pentagonal, and the like, for example. In certain embodiments, the flow paths 66 are substantially evenly spaced apart and have substantially the same hydraulic diameter. In other embodiments, a flow resistance is gradually increased within the discharge device 24 across the flow distribution assembly 44 from the region adjacent the inlet 36 to a region opposite the inlet 36 by increasing a space between the flow paths 66, decreasing the hydraulic diameter of the flow paths 66, or a combination thereof. For example, the first plate 60 shown in FIGS. 2-3 includes a plurality of sections each of the section having different spacing between the flow paths 66. A cross-sectional flow area of each of the sections in a general direction of the flow of fluid into the discharge device 24 is less than a cross-sectional flow area of the adjacent one of the sections. Thus, the cross-sectional flow area of the first plate 60 progressively decreases in the general direction of the flow of fluid into the discharge device 24.

In yet other embodiments, the flow resistance within the discharge device 24 varies across the flow distribution assembly 44 from the region adjacent the inlet 36 to the region opposite the inlet 36. For example, the cross-sectional flow area of each of the sections in the general direction of the flow of fluid into the discharge device 24 prior to a transition point is greater than the cross-sectional flow area of an adjacent one of the sections, and the cross-sectional flow area of each of the sections in the general direction of the flow of fluid into the discharge device 24 after the transition point is less than the cross-sectional flow are of an adjacent one of the sections. Thus, the cross-sectional flow area of the first plate 60 progressively increases in the general direction of the flow of fluid into the discharge device 24 from region adjacent the inlet 36 to the transition point and progressively decreases in the general direction of the flow of fluid into the discharge device 24 from the transition point to the region opposite the inlet 36. It is understood, however, that the flow paths 66 can be formed in the first plate 60 in any suitable pattern and have any suitable hydraulic diameter to produce a substantially uniform distribution of the flow of fluid from the discharge device 24 as desired.

The second plate 62 includes a plurality of flow paths 70 formed through a thickness of the second plate 62. The thickness of the second plate 62 shown is in a range of about 6 mm to about 10 mm, and more specifically 8 mm. The flow paths 70 shown have a hexagonal cross-sectional shape. It is understood, however, that the flow paths 70 can have any cross-sectional shape as desired such as circular, rectangular, square, pentagonal, and the like, for example. A length to hydraulic diameter ratio of each of the flow paths 70 is at least four (4) to direct the flow of fluid in a substantially perpendicular direction to the general direction of the flow of fluid into the discharge device for distribution of the fluid into the passenger compartment of the vehicle 12. It is understood that the second plate 62 and the flow paths 70 formed therein can have any suitable dimensions as desired. In certain embodiments, the flow paths 70 are substantially evenly spaced apart and have substantially the same hydraulic diameter. In other embodiments, a space between the flow paths 70 and/or the hydraulic diameter of the flow paths 70 can vary across the second plate 62 in the general direction of the flow of fluid into the discharge device 24. It is understood that the flow paths 70 can be formed in the second plate 62 in any suitable pattern and have any suitable hydraulic diameter as desired.

The third plate 64 includes a plurality of flow paths 74 formed through a thickness of the third plate 64. The thickness of the third plate 64 shown is in a range of about 1 mm to about 3 mm, and more specifically 2 mm. It is understood that the third plate 64 and the flow paths 74 formed therein can have any suitable dimensions as desired. The flow paths 74 shown have a circular cross-sectional shape. It is understood, however, that the flow paths 74 can have any cross-sectional shape as desired such as rectangular, square, pentagonal, hexagonal, and the like, for example. As shown in FIGS. 2-3, the flow paths 74 are substantially evenly spaced apart and have substantially the same hydraulic diameter. In certain embodiments, the flow paths 74 are evenly spaced at 40 mm centers and have a hydraulic diameter of 25 mm. It is understood, however, that the spacing between the flow paths 74 and/or a hydraulic diameter of the flow paths 74 can vary across the third plate 64 in the general direction of the flow of fluid into the discharge device 24. It is understood that the flow paths 74 can be formed in the third plate 64 in any suitable pattern and have any suitable hydraulic diameter as desired. Although the hydraulic diameter of each of the flow paths 74 of the third plate 64 is larger than the hydraulic diameter of each of the flow paths 70 of the second plate 62, a cumulative cross-sectional flow area of the third plate 64 is less than a cumulative cross-sectional flow area of the second plate 62 to increase a velocity of the flow of fluid into the passenger compartment of the vehicle 12. As a result, dispersion of the flow of fluid from the discharge device 24 caused by surrounding fluid flows is minimized ensuring that the flow of fluid from the discharge device 24 can be felt by passengers of the vehicle 12.

As illustrated in FIG. 3, the first plate 60 and the second plate 62 are received in stacked relationship in the third plate 64 to form the flow distribution assembly 44. In certain embodiments, a first end portion of the flow distribution assembly 44 is coupled to the discharge device 24 by an interference connection formed between the flow distribution assembly 44 and a receiving element 76 formed in the rear wall section 52 of the discharge device 24. Intermediate portions and an opposite second end portion of the flow distribution assembly 44 are coupled to the discharge device 24 by a plurality of fasteners 78. As shown, the fasteners 78 can be received in structural supports 80 integrally formed in the discharge device 24. Various other means can be employed to couple the flow distribution assembly 44 to the discharge device 24 such as adhesive bonding, mechanical fasteners (i.e. screws, retaining clips), and the like, for example. More particularly, the flow distribution assembly 44 is coupled to the discharge device 24 by any suitable means which minimizes noise and vibration of the fluid flow system 10.

In operation, the fluid flow element 32 of at least one of the supply sources 16 causes a flow of fluid to enter the fluid flow system 10 through the inlet opening of the respective inlet duct 14. The flow of fluid is then either heated or cooled by the conditioning device 34. Once conditioned, the fluid flows from the supply source 16 through the respective pillar duct 18 and into the respective discharge device 24. The flow of conditioned fluid enters the inlet 36 of the discharge device 24 and flows through the flow paths 40 of the diffuser 38 to be substantially uniformly distributed across the width of the discharge device 24. A portion of the flow of the conditioned fluid entering the discharge device 24 adjacent the inlet 36 is directed into the flow paths 66 of the first plate 60 of the flow distribution assembly 44 adjacent thereto by the radius R of the rear wall section 52 and the angled upper wall section 48. The remainder of the flow of conditioned fluid continues to progress through the discharge device 24 and is directed by the angled upper wall section 48 into the flow paths 66 of the first plate 60 of the flow distribution assembly 44 adjacent thereto. As a result, the flow of conditioned fluid decreases in mass across the flow paths 66. Because of the angled upper wall section 48 and the configuration of the flow paths 66, a substantially constant velocity of the flow of conditioned fluid is maintained as the mass of the flow of fluid decreases in the general direction of the flow of conditioned fluid into the discharge device 24. As such, the distribution of the flow of conditioned fluid among the flow paths 66 is substantially uniform, maximizing a performance and an efficiency of the fluid flow system 10. The flow of conditioned fluid then enters into the flow paths 70 of the second plate 62. The flow paths 70 of the second plate 62 direct the flow of conditioned fluid into the third plate 64 of the flow distribution assembly 44. As the flow of conditioned fluid enters and flows through the flow paths 74 of the third plate 64, a velocity of the flow of fluid is increased to ensure that the flow of conditioned fluid is felt by the passengers of the vehicle.

From the foregoing description, one ordinarily skilled in the art can easily ascertain the essential characteristics of this invention and, without departing from the spirit and scope thereof, can make various changes and modifications to the invention to adapt it to various usages and conditions.

What is claimed is:

1. A discharge device for a fluid flow system, comprising:
a flow distribution assembly including a plurality of plates in stacked relation, each of the plates having a plurality of flow paths formed therein.

2. The discharge device according to claim 1, wherein at least one of the plates is configured to substantially uniformly distribute a fluid flow among the flow paths of the at least one of the plates.

3. The discharge device according to claim 1, wherein at least one of the plates is configured to direct a fluid flow in a direction substantially perpendicular to a general direction of the fluid flow into the discharge device.

4. The discharge device according to claim 1, wherein at least one of the plates is configured to increase a velocity of a fluid flow from the discharge device.

5. The discharge device according to claim 1, wherein at least one of a spacing between the flow paths and a hydraulic diameter of each of the flow paths of at least one of the plates varies across the at least one of the plates in a general direction of a fluid flow into the discharge device.

6. The discharge device according to claim 1, wherein at least one of the flow paths of at least one of the plates has a length to hydraulic diameter ratio of at least four.

7. The discharge device according to claim 1, wherein a cumulative cross-sectional flow area of one of the plates is less than a cumulative cross-sectional flow area of an adjacent one of the plates to increase a velocity of a fluid flow from the discharge device.

8. The discharge device according to claim 1, further comprising a diffuser disposed in an inlet of the discharge device, the diffuser configured to substantially uniformly distribute a fluid flow entering the discharge device.

9. The discharge device according to claim 1, wherein a thickness of at least one of the plates is in a range of about 1 mm to about 3 mm.

10. The discharge device according to claim 1, wherein a thickness of at least one of the plates is in a range of about 6 mm to about 10 mm.

11. A discharge device for a fluid flow system, comprising:
an outer wall; and
a flow distribution assembly coupled to the outer wall to form a chamber for receiving a fluid flow therein, wherein the flow distribution assembly includes a plurality of plates, each of the plates having a plurality of flow paths formed therein, wherein at least one of the plates is configured to at least one of substantially uniformly distribute the fluid flow among the flow paths of the at least one of the plates, direct the fluid flow in a direction substantially perpendicular to a general direction of the fluid flow into the discharge device, and increase a velocity of the fluid flow from the discharge device.

12. The discharge device according to claim 11, wherein at least one of a spacing between the flow paths and a hydraulic diameter of each of the flow paths of at least one of the plates varies across the at least one of the plates in the general direction of the fluid flow into the discharge device.

13. The discharge device according to claim 11, wherein at least one of the flow paths of at least one of the plates has a length to hydraulic diameter ratio of at least four.

14. The discharge device according to claim 11, wherein a cumulative cross-sectional flow area of one of the plates is less than a cumulative cross-sectional flow area of an adjacent one of the plates to increase a velocity of the fluid flow from the discharge device.

15. The device according to claim 11, further comprising a diffuser disposed in an inlet of the discharge device, the diffuser configured to substantially uniformly distribute the fluid flow entering the chamber.

16. The device according to claim 15, wherein a section of the outer wall is angled from the inlet of the discharge device to an end of the discharge device opposite the inlet.

17. The device according to claim 11, wherein the outer wall includes a radius formed therein to direct the fluid flow into the flow paths of at least one of the plates.

18. The device according to claim 11, wherein at least a portion of an inner surface of the outer wall has an insulating layer disposed thereon.

19. A fluid flow system, comprising:
a supply source for providing a fluid flow;
at least one duct fluidly connected to the supply source; and
a discharge device fluidly connected to the at least one duct, the discharge device including a flow distribution assembly including a substantially planar first plate, a substantially planar second plate, and a substantially planar third plate, each of the first plate, the second plate, and the third plate having a plurality of flow paths formed therein, wherein the first plate is configured to substantially uniformly distribute a fluid flow among the flow paths of the first plate, the second plate is configured to direct the fluid flow in a direction substantially perpendicular to a general direction of the fluid flow into the discharge device, and the third plate is configured to increase a velocity of the fluid flow from the discharge device.

20. The discharge device according to claim 19, wherein the second plate is disposed between the first plate and the third plate in stacked relation to form the flow distribution assembly.
